(19) United States
(12) Patent Application Publication
(10) Pub. No.: US 2013/0003110 A1
(43) Pub. Date: Jan. 3, 2013

(54) PERSONALIZED IDENTIFIERS FOR PRINTERS

(76) Inventors: Harish B. Kamath, Bengalooru (IN); Rajesh Bhatia, Bangalore (IN)

(21) Appl. No.: 13/174,197

(22) Filed: Jun. 30, 2011

(51) Int. Cl. G06K 15/02

(52) U.S. Cl. 358/1.15

(57) ABSTRACT

In one embodiment, data is received at a computer system. Profile information for a user of a network-connected printer is parsed from the data. A personalized identifier for the printer is generated that incorporates the information. The identifier is registered with a registry of computing device identifiers.

### BACKGROUND

Certain printers are capable of sending and receiving communications and print jobs via the internet without being connected to a desktop computer, laptop computer, or other host computing device. Such printers typically are assigned an email address or other identifier at the time the printer is first connected to the internet, in order that print jobs and other communications can be directed to the printer.

### BRIEF DESCRIPTION OF THE DRAWINGS

The accompanying drawings illustrate various embodiments and are a part of the specification. The illustrated embodiments are examples and do not limit the scope of the claims. Throughout the drawings, identical reference numbers designate similar, but not necessarily identical elements.

FIGS. 1-2 are block diagrams illustrating systems according to various embodiments.

FIG. 3 is an example of creating a personalized identifier for a network-connected printer utilizing electronic business card data, according to various embodiments.

FIG. 4 is a block diagram illustrating a system according to various embodiments.

FIG. 5 is an example of creating personalized identifiers for a network-connected printer utilizing electronic business card data, according to various embodiments.

FIG. 6 is a block diagram illustrating a system according to various embodiments.

FIGS. 7 and 8 are examples of creating personalized identifiers for a network-connected printer utilizing email data, according to various embodiments.

FIG. 9 is a flow diagram depicting steps taken to implement various embodiments.

The same part numbers designate the same or similar parts throughout the figures.

### DETAILED DESCRIPTION OF EMBODIMENTS

An advantage of an internet-connected printer is the ability for the owner of the printer and other persons to send print jobs to the printer via email. A limitation to this advantage is that in some cases the sending of print jobs via email can be unwieldy due to the arbitrary nature of email addresses that are typically assigned to internet-connected printers during setup. Difficulty in remembering arbitrary string email addresses can be exacerbated by other factors such as length of the email addresses, the frequency with which the address is changed, and/or the number of printers for which the user is tracking email addresses.

A user's experience with an internet-connected printer should be enhanced if the printer has an email address or other identifier that is easy for the user to remember and utilize. Some systems may allow a user to manually establish or rename an email address for a printer, but such an approach has the limitation that the users may need to invest time in researching how to create or change the email address. Accordingly, various embodiments described herein were developed in an effort to make it easier to create and register personalized, user-friendly email addresses and other identifiers for network-connected printers.

It should be noted that while the disclosure is discussed frequently with reference to email addresses and internet-connected printers, the teachings of the present disclosure are not so limited and can be applied to any identifier for any network-connected printer.

As used herein, a “network-connected printer” refers to a printer that can be connected to a network, to be capable of obtaining content, sending and receiving messages, accessing internet content, and/or accessing internet applications via the network. In examples, the network may be a proprietary network, a secured network, an open network, an intranet, an extranet, an internet or the Internet. “Profile information” refers to information or data that describes characteristics of a person, organization, or other thing. Profile information for a person or organization may include, but is not limited to, a name, title, address, telephone number, and/or zip code. An “identifier” for a printer refers to something that identifies, indicates, or names a printer. ‘Electronic business card’ refers to any electronic document configured for conveying profile information regarding a user via a computing device. “Printer” or “printing device” refers to any electronic device that prints and includes multifunctional electronic devices that perform additional functions such as scanning and/or copying.

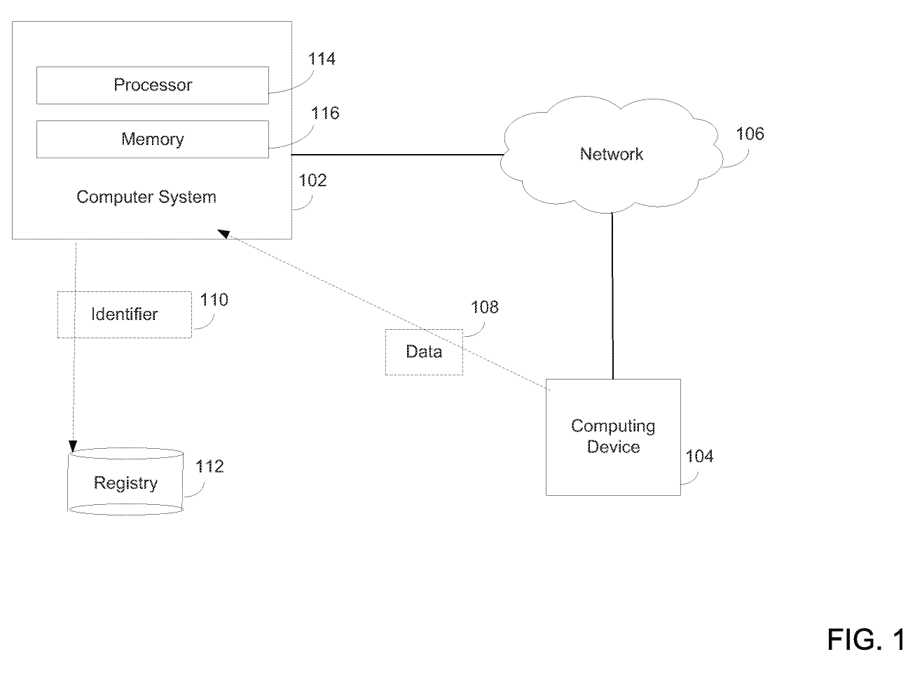

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

FIG. 1 shows a computer system 102 and a computing device 104 connected to a network 106. Computer system 102 represents generally any computing device or group of computing devices capable of sending network requests and content to, and otherwise communicating with, computing device 104. via network 106. In embodiments, computer system 102 may be or include a server, desktop computer, laptop computer, mobile computing device, tablet computer, and/or any other computing device.

Computing device 104 represents generally any computing device or group of computing devices capable of sending networks requests and content to, and otherwise communicating with, computer system 102. In embodiments, computer system 102 may be or include a desktop computer, laptop computer, mobile computing device, smart phone tablet computer, printer, all-one-one printing and scanning device, and/or any other computing device.

Data 108 is received at computer system 102 via computing device 104. In an example, computing device 104 may be a network-connected printer. In another example, computing device 104 may be a web server hosting a web page, e.g., a configuration web page, associated with a network-connected printer.

The received data 108 may be in either structured form or unstructured form. In an example, the data 108 may be in the form of electronic business card data that is uploaded from computing device 104 to computer system 102. In another example, the data 108 received at computer system 102 is an email that is to be sent to an internet-connected printer. In another example, the data 108 received at computer system 102 from computing device 104 may be in the form of a document that is attached to an email, the document intended for printing at an internet-connected printer.

Profile information for a user of a network-connected printer is parsed from the received data 108. In an example in which the received data 108 is an email, the profile information may be parsed from header of the email, from an email address contained within the email, or from the body of the email. In an example in which the received data 108 is an email with an attached document, the profile information may be parsed from the document.

Computer system 102 generates a personalized identifier 110 for a network-connected printer, the identifier incorporating the profile information. The generated identifier 110 is registered with a registry 112 of computing device identifiers in order that print jobs addressed to printer via the identifier 110 and sent via the network are properly received.

In this manner, a user-friendly email address or other personalized identifier for an internet-connected printer is easily created and registered, without the need for a user to invest substantial time in learning how to manually create or change the identifier.

The functions and operations described with respect to computer system 102 may be implemented as a computer-readable storage medium containing instructions executed by a processor (e.g., processor 114) and stored in a memory (e.g., memory 116). In a given implementation, processor 114 may represent multiple processors, and memory 116 may represent multiple memories. Processor 114 represents generally any instruction execution system, such as a computer/processor based system or an ASIC (Application Specific Integrated Circuit), a computer, or other system that can fetch or obtain instructions or logic stored in memory 116 and execute the instructions or logic contained therein. Memory 116 represents generally any memory configured to store program instructions and other data.

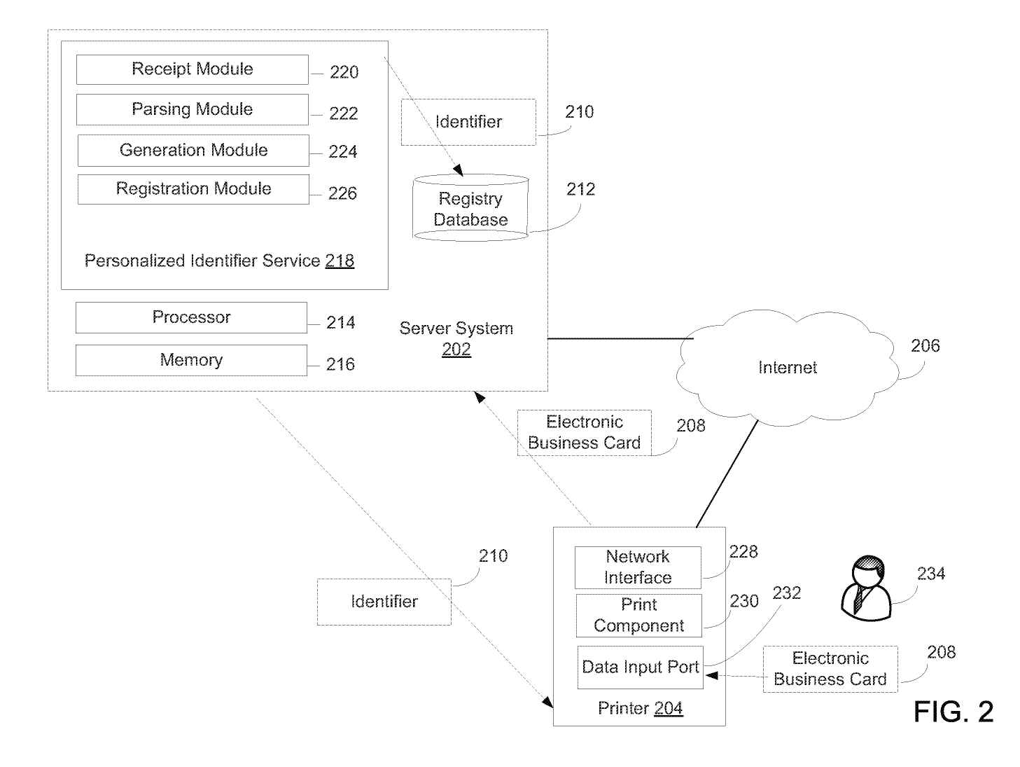

FIG. 2 is a block diagram that includes a server system according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

As illustrated in FIG. 2, server system 202 may be a single physical device or it may be distributed among multiple physical devices connected over a network (e.g., the Internet). For example, server system 202 may represent a cloud computing infrastructure (i.e., the cloud). In a cloud computing infrastructure, various components/modules of server system 202 may share resources and/or act in concert even though they might be in different physical locations and/or operating on different physical devices.

FIG. 2 shows server system 202, and printer 204 connected to an internet 206. Server system 202 includes a registry database 212 and a personalized identifier service 216, the service 216 including a receipt module 220, parsing module 222, generation module 224, and registration module 226.

Printer 204 represents generally a computing device that is operable to produce printed output and to send and receive communications and content over the internet 206. Printer 204 is shown to include network interface 228, print component 230, and data input port 232. Network interface 228 represents generally any combination of hardware and programming configured for electronically connecting printer 204 to internet 206. Print component 230 represents generally any combination of hardware and programming configured to produce printed output. Data input port 232 represents generally any combination of hardware and programming configured to receive an electronic business card 208 or other profile information regarding a user 234 of printer 204. In an example, data input port 232 may be a USB port.

Receipt module 220 receives data in the form of an electronic business card 208, the card 208 including profile information for a user 234 of internet-connected printer 204. In an example, user 234 may supply an electronic business card in “vCard” format to the printer 204 via inserting a flash drive, thumb drive or other memory device that contains the card 208 into data input port 232 at printer 204. In another example, the electronic business card may be populated at the printer 204 by user 208 via a touchpad or other user interface at printer 204.

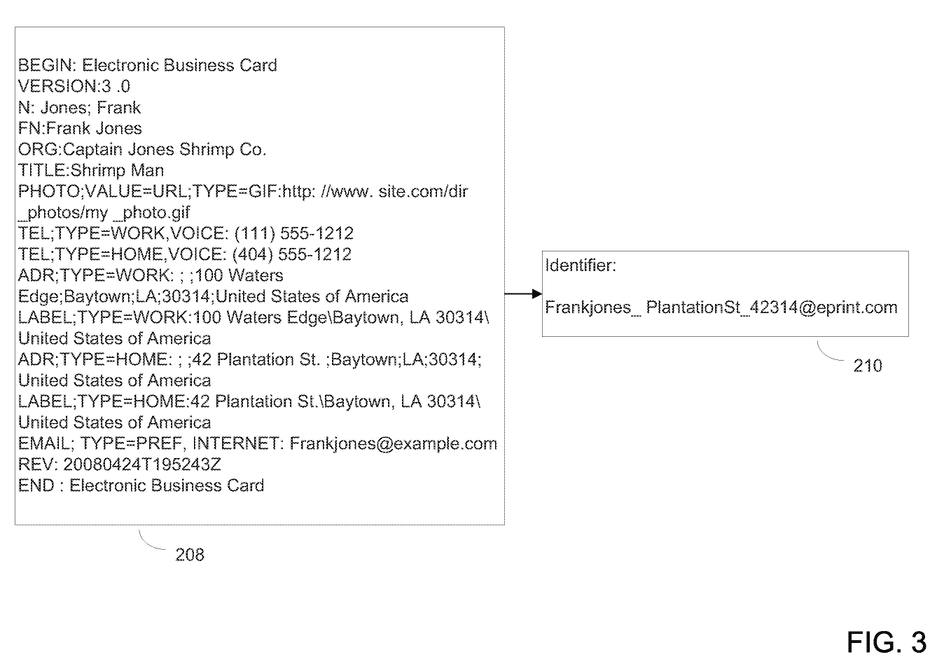

Detail of an example electronic business card 208 is provided at FIG. 3. In this example, the profile information is that of a user 234 (FIG. 2) named “Frank Jones” and employed by “Captain Jones Shrimp Co.” The electronic business card 208 includes profile data in data fields “N,” “FN,” “ORG,” “TITLE,” “PHOTO; VALUE=URL;TYPE=GIF,” “TEL;TYPE=WORK, VOICE,” “TEL;TYPE=HOME, VOICE,” “ADR; TYPE=WORK,” “LABEL; TYPE:WORK,” “ADR; TYPE=HOME,” “LABEL; TYPE=HOME,” and “EMAIL; TYPE=PREF, INTERNET.”

Parsing module 220 parses profile information for user 234 from the data fields of electronic business card 208. Generation module 224 generates a personalized identifier 210 for internet-connected printer 204, the identifier 210 incorporating the parsed profile information. Returning to FIG. 3, parsing module 220 generates a personalized identifier 210 “Frankjones_PlantationSt_{—}42314@eprint.com” incorporating the name and portions of the home street address of the user 234.

Registration module 224 registers the generated “Frankjones_PlantationSt_{—}42314@eprint.com” identifier 210 with a registry database 212 of identifiers of computing devices connected to the internet 206. FIG. 2 illustrates a registry database included within the server system 202. In another example, the registry is accessible to server system 202 via the internet 206, but is separate from server system 202. In the example shown in FIG. 2, the generated identifier 210 is additionally sent to the user 234 via internet-connected printer 204 via the internet 206. This presumes the printer 204 was at least temporarily connectable to internet 206 prior to the issuance of the identifier 210. In an example in which the printer 204 is not connected to the internet at the time of generation of the identifier 210, the identifier 210 may be provided to user 234 via an email retrievable at another computing device connected to the internet 206.

The functions and operations described with respect to server system 202 may be implemented as a computer-readable storage medium containing instructions executed by a processor (e.g., processor 214) and stored in a memory (e.g., memory 216).

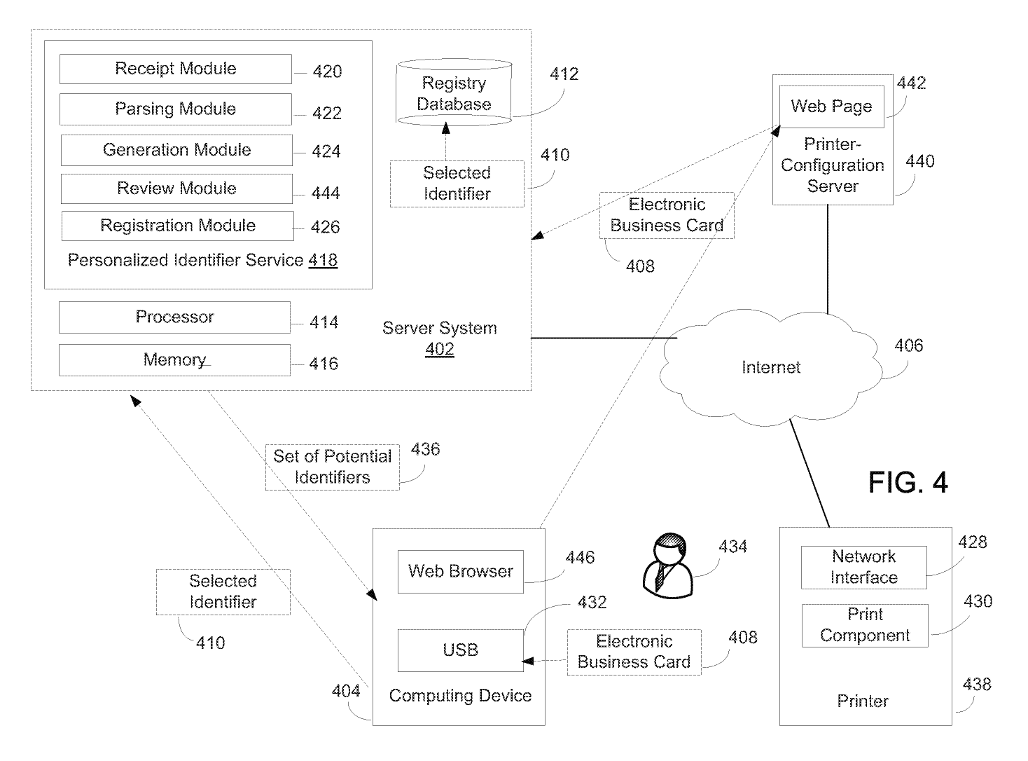

FIG. 4 is a block diagram that includes a server system according to various embodiments. FIG. 4 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

As illustrated in FIG. 4, server system 402 may be a single physical device or it may be distributed among multiple physical devices connected over a network (e.g., the Internet). For example, server system 402 may represent a cloud computing infrastructure (i.e., the cloud). In a cloud computing infrastructure, various components/modules of server system 402 may share resources and/or act in concert even though they might be in different physical locations and/or operating on different physical devices.

FIG. 4 shows server system 402, computing device 404, printer 438, and printer-configuration server 440 connected to internet 406. Server system 402 includes a registry database 412 and a personalized identifier service 418, the service 418 including a receipt module 420, parsing module 422, generation module 424, review module 444, and registration module 426.

Printer 438 represents generally a computing device that is operable to produce printed output and to send and receive communications and content over the internet 406. Printer 438 is shown to include network interface 428 and print component 430. Network interface 428 represents generally any combination of hardware and programming configured for electronically connecting printer 438 to internet 406. Print component 430 represents generally any combination of hardware and programming configured to produce printed output.

Printer-configuration server 440 represents generally any combination of hardware and programming configured to host a web page 444, which web page can be accessed by user 434 via computing device 404 to perform configuration and/or set-up operations for internet-connected printer 438. After such configuration and/or setup, printer 438 is capable of receiving print jobs from user 434 and other authorized senders via the internet 406.

Receipt module 420 receives data in the form of an electronic business card 408, the card 408 including profile information for user 434 of internet-connected printer 438. In an example, user 434 may supply an electronic business card in “vCard” format to computing device 404 (e.g., a laptop computer) distinct from the printer 438 via inserting a flash drive, thumb drive or other memory device that contains the card 408 into a USB port 432 at computing device 404, Utilizing the web browser 446, computing device 404 sends the electronic business card 408 via the internet to printer-configuration server 440.

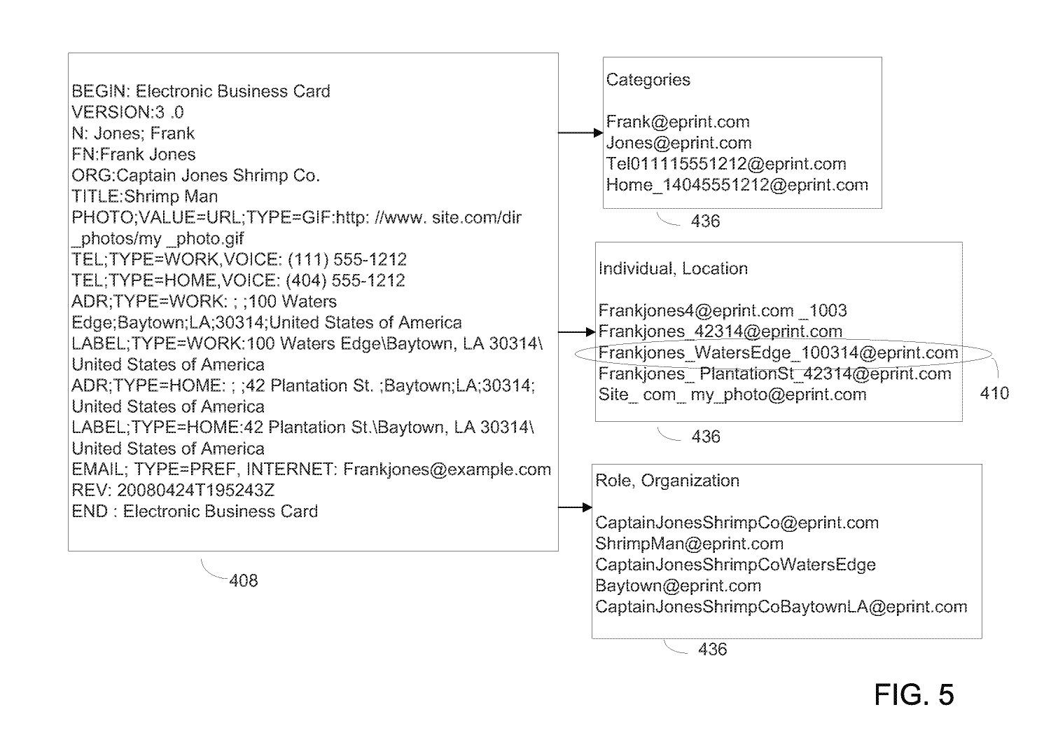

Detail of an example electronic business card 408 is provided at FIG. 5. In this example, the profile information is that of a user 434 (FIG. 4) named Frank Jones, employed by Captain Jones Shrimp Co, Parsing module 420, parses from the data fields “N,” “FN,” “ORG,” “TITLE,” “PHOTO; VALUE=URL;TYPE=GIF,” “TEL;TYPE=WORK, VOICE,” “TEL;TYPE=HOME, VOICE,” “ADR; TYPE=WORK,” “LABEL; TYPE=WORK”; “ADR; TYPE=HOME”; “LABEL; TYPE-HOME”; and “EMAIL; TYPE=PREF, INTERNET” profile information for user 434.

Generation module 424 generates a set of potential identifiers 436 for internet-connected printer 438, with each of the identifiers in the set 436 incorporating parsed profile information. Returning to FIG. 5, generation module 424 generates a set 436 of potential personalized identifiers including four potential identifiers under the header “Categories,” five potential identifiers under the header “Individual, Location,” and five potential identifiers under the header “Roles, Organization.”

Review module 444 provides the set 436 to user 434 for review by sending the set to the configuration server 440 for printer 438, User 434 interacts with a web page 442 hosted by printer configuration server 440, and selects a selected identifier 410 that is one of the set 436. Returning to FIG. 5, the selected identifier 410 “Frankjones_WatersEdge_{—}100314@eprint.com” incorporates the name and portions of the work street address of user 434.

After the user 434 selects an identifier from the set 436 and the printer configuration server 440 receives the selection, the selected identifier 410 is received at server system 402 from printer configuration server 440. In another embodiment, the selected identifier 410 may be received at server system 402 via the printer 438.

Registration module 424 compares the selected identifier 410 “Frankjones_WatersEdge_{—}100314@eprint.com” to existing identifiers contained within a registry database 412 of identifiers of computing devices connected to the internet 406 to determine whether the selected identifier 410 is distinct according to a rule. In an example, a rule may state that two identifiers are sufficiently distinct if there is any difference in the characters of the identifiers. In another example, a rule may set a threshold of three points of difference in identifiers in order for the identifiers to be classified as distinct. In response to ascertaining that the selected identifier 410 is distinct according to the rule, the selected identifier 410 is registered with the registry database 412.

The functions and operations described with respect to server system 402 may be implemented as a computer-readable storage medium containing instructions executed by a processor (e.g., processor 414) and stored in a memory (e.g., memory 416).

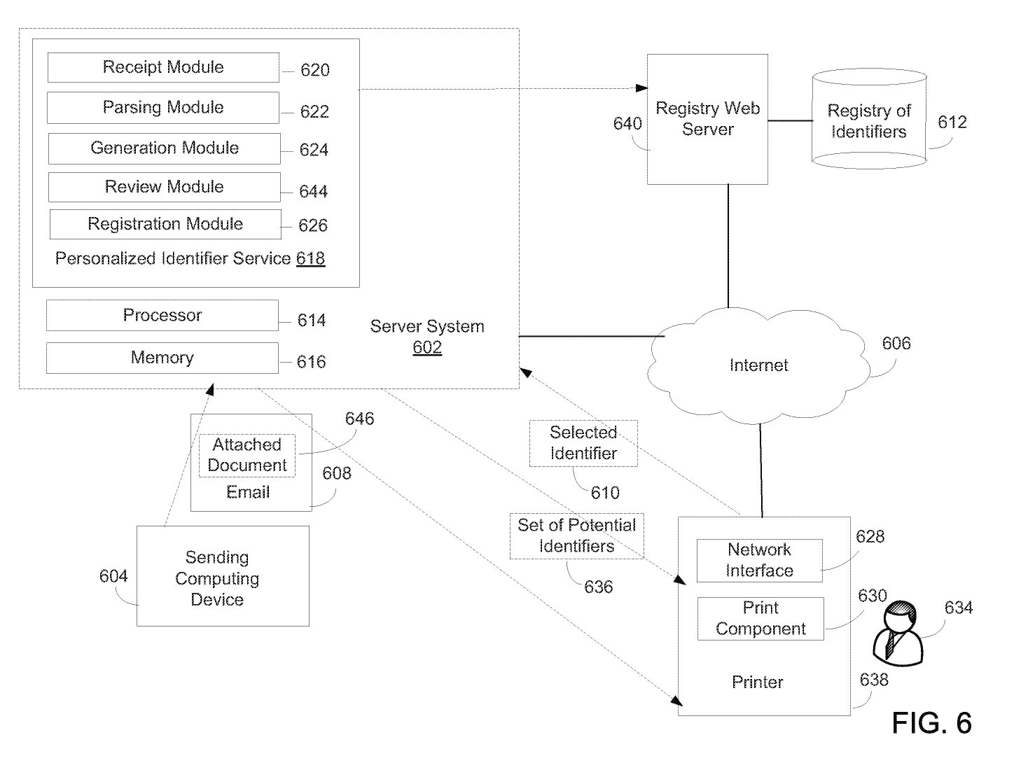

FIG. 6 is a block diagram that includes a server system according to various embodiments. FIG. 6 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

As illustrated in FIG. 6, server system 602 may be a single physical device or it may be distributed among multiple physical devices connected over a network (e.g., the Internet). For example, server system 602 may represent a cloud computing infrastructure (i.e., the cloud). In a cloud computing infrastructure, various components/modules of server system 602 may share resources and/or act in concert even though they might be in different physical locations and/or operating on different physical devices.

FIG. 6 shows server system 602, sending computing device 604, printer 638, and registry web server 640 connected to internet 606. Server system 602 includes a personalized identifier service 618, the service 618 including a receipt module 620, parsing module 622, generation module 624, review module 644, and registration module 626.

Sending computing device 604 represents generally any computing device or group of computing devices capable of sending network requests and content to, and otherwise communicating with, server system 602 via a network 606. In embodiments, sending computing device 604 may be a desktop computer, laptop computer, mobile computing device, tablet computer, and/or any other computing device.

Printer 638 represents generally a computing device that is operable to produce printed output and to send and receive communications and content over the internet 606. Printer 638 is shown to include network interface 628 and print component 630. Network interface 628 represents generally any combination of hardware and programming configured for electronically connecting printer 638 to internet 606. Print component 630 represents generally any combination of hardware and programming configured to produce printed output.

Registry web server 640 represents generally any combination of hardware and programming configured to maintain and provide server system 602 with access, via internet 606, to a registry 612 of identifiers of computing devices connected to the internet 606.

Receipt module 620 receives data in the form of an email 608, originating from sending computing device 404, to be sent via the internet 606 to printer 638. The email 608 may be received via a networking protocol, including but not limited to Transmission Control Protocol/Internet Protocol (“TCP/IP”), HyperText Transfer Protocol (“HTTP”), Simple Mail Transfer Protocol (“SMTP”), Extensible Messaging and Presence Protocol (“XMPP”), and/or Session Initiation Protocol (“aSIP”).

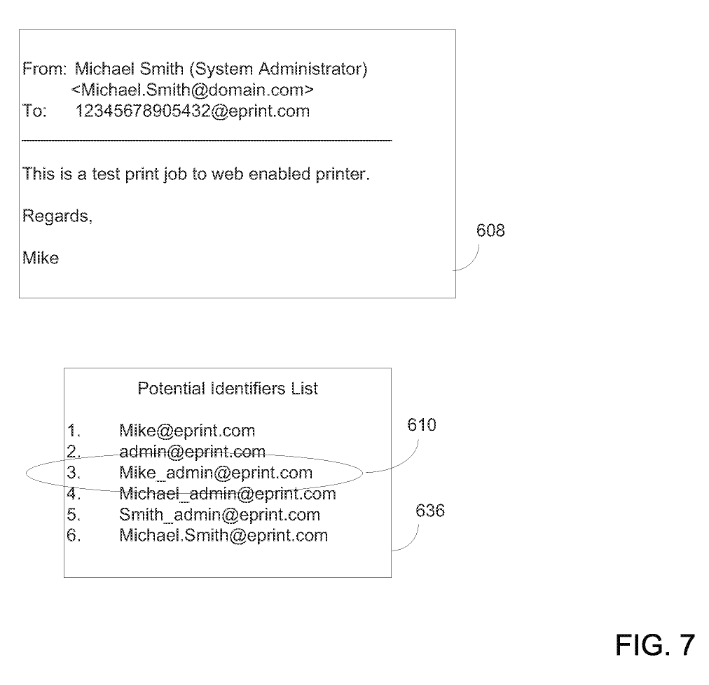

Detail of an example email is provided at FIG. 7. In this example, a system administrator named Michael Smith sends an email message to internet connected printer 638 (FIG. 6) that has a default email address of “12345678905432@eprint.com.” The email 608 is sent by the system administrator as a test print job, and contains a closing salutation “Regards, Mike.”

Parsing module 622, parses profile information for user 632 from the “From:” and “To:” data fields, from metadata contained within the email, and/or from the salutation “Regards, Mike”. In the case of the salutation, the profile information “Mike” is parsed by identifying the text following the “Regards” closing statement in the email. In other examples, rules are established that parse profile information based upon other closing statements, (e.g., “Sincerely,” “Cheers,” “Take care,” etc.), or upon a greeting within the email 608 (e.g., “Dear,” “Hello,” or “Hi”).

Generation module 624 generates a set of potential identifiers 636 for internet-connected printer 638. Returning to FIG. 7, generation module 624 generates a set of potential personalized identifiers 636 including “Mike@eprint.com.” “admin@eprint.com,” “Mike_admin@eprint.com,” “Michael_admin@eprint.com,” “Smith_admin@eprint.com,” and “Michael.Smith@eprint.com.”

Review module 644 provides the set 636 to user 634 for review by sending the set to the printer 638. User 634 interacts with printer 638 to select a selected identifier 610 that is one of the set 636. Returning to FIG. 7, the selected identifier 610 Mike_admin@eprint.com incorporates profile information from the “From:” data field and from the text following the “Regards” closing.

After the user 634 makes the selection at printer 638 and the printer configuration server 640 receives the selection, the selected identifier 610 is received at server system 602 from printer 638 via internet 606. Registration module 624 compares the selected identifier 610 “Mike_admin@eprint.com” to existing identifiers contained within a registry of identifiers 612 maintained at registry web server 640, to determine whether the selected identifier 610 is distinct according to an applicable rule. In response to ascertaining that the selected identifier 610 is distinct according to the rule, the selected identifier 610 is registered with the registry 612.

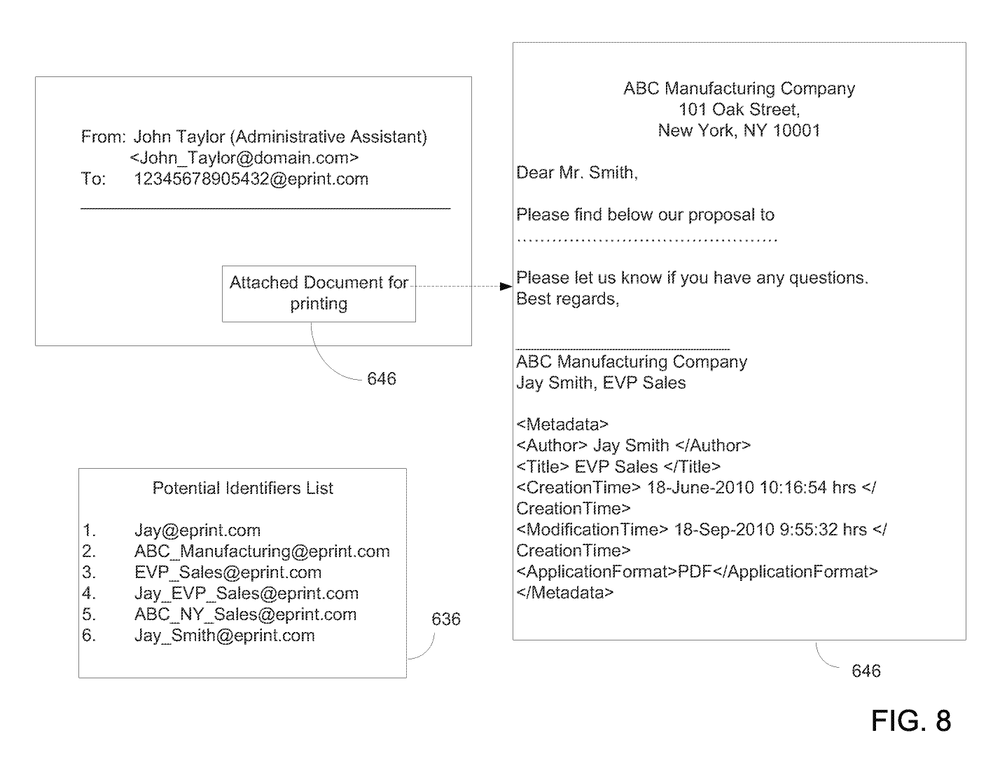

In another example illustrated in FIG. 8, an email received at receipt module 620 (FIG. 6) may include an attached document 646 (FIGS. 6 and 8). Example document formats for the attached document 646 include, but are not limited to, PDF and other page description formats, HTML, RSS feeds and other XML formats, JPEG, TIFF and other image formats, and document formats such as Microsoft® Word, Microsoft Excel®, and Adobe InDesign®.

In the example of FIG. 8, administrative assistant “John Taylor” sends an email message to internet connected printer 638 (FIG. 6) using the default email address of “12345678905432@eprint.com.” The email includes an attached document 646 to be printed at printer 638. The attached document 646 is a proposal letter from ABC Manufacturing Company to a prospective client, the letter to be signed by “Jay Smith, EVP Sales.” Profile information is parsed from the letterhead, the closing salutation, and/or metadata of the attached document 646. In this example, document 646 contains the metadata “<Metadata> <Author>Jay Smith </Author> <Title>EVP Sales </Title> <CreationTime>18-Jun.-2010 10:16:54 hrs </CreationTime> <ModificationTime>18-Sep.-2010 9:55:32 hrs </CreationTime> <ApplicationFormat>PDF</ApplicationFormat> </Metadata>.” In other examples, metadata may include other data about the document, such as document category, section descriptions, content tags, and/or relationship to other documents. A set of potential personalized identifiers 836 is generated utilizing the profile information: “Jay@eprint.com,” “ABC_Manufacturing@eprint.com,” “EVP_Sales@eprint.com,” “Jay_EVP_Sales@eprint.com.” “ABC_NY_Sales@eprint.com.” and “Jay_Smith@eprint.com.” In yet another example, the profile information may be parsed from both the email 608 and the attached document 646.

The functions and operations described with respect to server system 602 may be implemented as a computer-readable storage medium containing instructions executed by a processor (e.g., processor 614) and stored in a memory (e.g., memory 616).

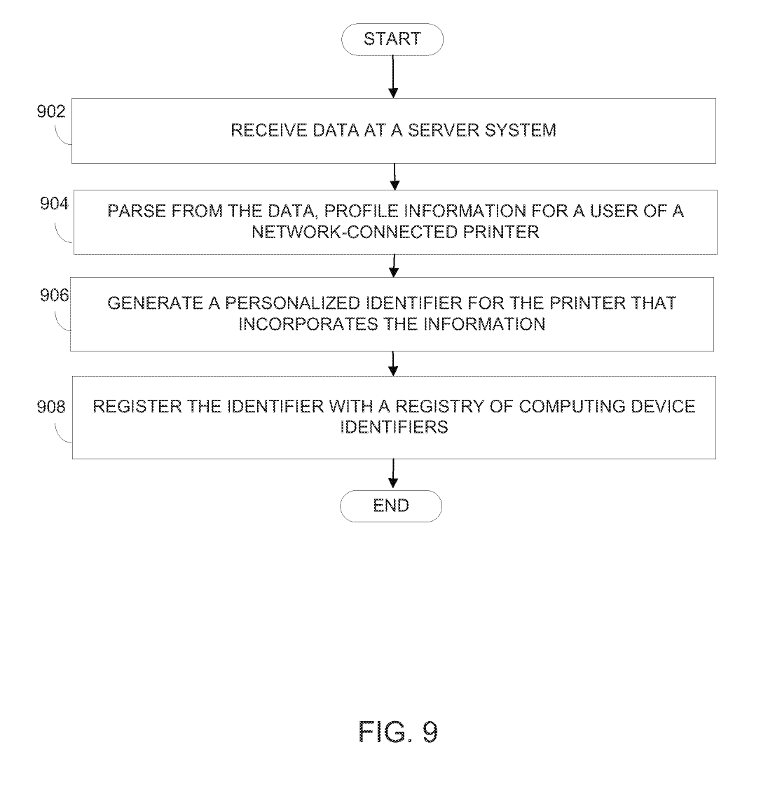

FIG. 9 is a flow diagram of operation in a system according to various embodiments. In discussing FIG. 9, reference may be made to the diagrams of FIGS. 1-8 to provide contextual examples. Implementation, however, is not limited to those examples. Starting with FIG. 9, data is received at a server system (block 902). Referring back to FIG. 2, the receipt module 220 may be responsible for implementing block 902.

Continuing with the flow diagram of FIG. 9, profile information for a user of a network-connected printer is parsed from the data (block 904). Referring back to FIG. 2, the parsing module 222 may be responsible for implementing block 904.

Continuing with the flow diagram of FIG. 9, a personalized identifier for the printer that incorporates the information is generated (block 906). Referring back to FIG. 2, the generation module 224 may be responsible for implementing block 906.

Continuing with the flow diagram of FIG. 9, the generated identifier is registered with a registry of computing device identifiers (block 908). Referring back to FIG. 2, the registration module 226 may be responsible for implementing block 908.

Although the flow diagram of FIG. 9 shows specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

Various modifications may be made to the disclosed embodiments and implementations without departing from their scope. Therefore, the illustrations and examples herein should be construed in an illustrative, and not a restrictive, sense.

What is claimed is:

1. A method to create a personalized identifier for a network-connected printer, comprising:
receiving data at a computer system;
parsing, from the data, profile information for a user of a network-connected printer;
generating a personalized identifier for the printer that incorporates the information;
registering the identifier with a registry of computing device identifiers.

2. The method of claim 1, wherein the data is received via the printer.

3. The method of claim 1, wherein the data is received via a web page associated with the printer.

4. The method of claim 1, wherein the data is structured data.

5. The method of claim 1 wherein the data is an electronic business card.

6. The method of claim 1, wherein the data is unstructured data.

7. The method of claim 1, wherein the data comprises an email.

8. The method of claim 7, wherein at least a portion of the information is parsed by identifying text following a greeting or closing statement in the email.

9. The method of claim 1, wherein the data comprises an email and an attached document to be sent to the printer, the document to be printed at the printer.

10. The method of claim 9, wherein the information is parsed from the email.

11. The method of claim 9, wherein the information is parsed from the document.

12. A system to create a personalized identifier for a network-connected printer, comprising:
a receipt module, configured to receive data at a computer system;
a parsing module, configured to parse from the data, profile information for a user of a network-connected printer:
a generation module, configured to generate a personalized identifier for the printer that incorporates the information;
a registration module, configured to register the identifier with a registry of computing device identifiers.

13. The system of claim 12, wherein the data comprises an email and an attached document to be sent to the printer, the document to be printed at the printer.

14. The system of claim 13, wherein the information is parsed from metadata of the email.

15. The system of claim 13, wherein the information ion is parsed from metadata of the document.

16. The system of claim 12, wherein
the registration module is further configured to compare the identifier to existing identifiers in the registry to determine whether the identifier is distinct, and
wherein the registering of the identifier with the registry occurs in response to determining that the identifier is distinct.

17. The system of claim 12,
wherein the identifier is generated as one of a set of potential personalized identifiers, and
further comprising a review module, configured to
provide the set to a user for review, and
receive a selected identifier that is one of the set.

18. The system of claim 17, wherein the selected identifier is received via the printer.

19. The system of claim 17, wherein the selected identifier is received via a web page associated with the printer.

20. A computer-readable storage medium containing instructions for creating a personalized identifier for a network-connected printer, the instructions when executed by a processor causing the processor to:
receive data at a server system via a network-connected printer;
parse, from the data, profile information for a user of the printer;
generate a set of potential personalized identifiers for the printer that incorporate the information;
provide the set to a user for consideration;
receive a first identifier from the set;
determine that the first identifier is distinct from existing computing device identifiers in a registry;
register the first identifier with the registry.
